(19) United States
(12) Patent Application Publication
(10) Pub. No.: US 2025/0300922 A1
(43) Pub. Date: Sep. 25, 2025

(54) NETWORK DEVICE USING NETWORK PROCESSING UNIT AND HARDWARE ACCELERATION CIRCUIT TO MEET SPEED TEST REQUIREMENTS OF HIGH-SPEED NETWORK AND ASSOCIATED NETWORK SPEED TEST METHOD

(71) Applicant: Airoha Technology (Suzhou) Limited, Suzhou City (CN)

(72) Inventors: WEIHUA HUANG, Nanjing City (CN); Fei Yan, Nanjing City (CN)

(73) Assignee: Airoha Technology (Suzhou) Limited, Suzhou City (CN)

(21) Appl. No.: 19/074,431

(22) Filed: Mar. 9, 2025

(30) Foreign Application Priority Data
Mar. 20, 2024 (WO) PCT/CN2024/082736

(51) Int. Cl. H04L 43/50; H04L 43/062

(52) U.S. Cl. CPC H04L 43/50; H04L 43/062

(57) ABSTRACT

A network device includes a storage device, a central processing unit (CPU), a hardware acceleration circuit, and a network processing unit (NPU). The storage device stores program codes. The CPU loads and executes the program codes to deal with a control function of a network speed test. The hardware acceleration circuit provides hardware-accelerated packet forwarding. The NPU interacts with the control function performed by the CPU, and deals with processing of data packets used for the network speed test. Transmission of the data packets between the network device and another network device is performed through the NPU and the hardware acceleration circuit, without intervention of the CPU.

### BACKGROUND OF THE INVENTION

### 1. Field of the Invention

The present invention relates to a network speed test design, and more particularly, to a network device and an associated network speed test method that use a network processing unit and a hardware acceleration circuit to meet speed test requirements of a high-speed network.

### 2. Description of the Prior Art

Transmission Control Protocol (TCP) is a protocol belonging to the transport layer. The TCP speed test is commonly employed to measure an upload (UL) speed of upstream transmission from a client to a server and a download (DL) speed of downstream transmission from a server to a client. The correctness and reliability of TCP packet transmission is ensured by several mechanisms. Therefore, the overall transmission process will be less efficient. However, for network speed measurement applications, the accuracy of the data transmission is not actually concerned. As the network speed continues to increase, the traditional TCP-based network speed test applications may encounter bottleneck and seriously underestimate the actual network speed.

User Datagram Protocol (UDP) is another protocol belonging to the transport layer. TCP and UDP are both transport layer protocols. The main difference between TCP and UDP is whether reliable transmission is provided. Specifically, TCP has high reliability, and UDP focuses on efficiency and does not care about packet loss. Recently, the UDP-based network speed test application is adopted as an alternative of the traditional TCP-based network speed test application.

When the UDP-based network speed test application is executed by a central processing unit (CPU) of a network device, the CPU is responsible for generating each packet required for UL speed measurement and receiving each packet required for DL speed measurement. However, the task of sending (or receiving) test packets requires frequent switching between a user space and a kernel space, which consumes a lot of processor resources and limits the speed of sending (or receiving) test packets. Furthermore, a packet buffer is generally allocated in an off-chip memory such as a dynamic random access memory (DRAM). The speed of sending (or receiving) packets is further limited due to longer DRAM access latency. The maximum network speed that can be measured by the typical UDP-based network speed test application that fully runs on the CPU may be far lower than the real speed of the network. As a result, the typical UDP-based network speed test application that fully runs on the CPU cannot meet the speed test requirements of a high-speed network.

### SUMMARY OF THE INVENTION

One of the objectives of the claimed invention is to provide a network device using a network processing unit and a hardware acceleration circuit to meet speed test requirements of a high-speed network and an associated network speed test method.

According to a first aspect of the present invention, an exemplary network device is disclosed. The exemplary network device includes a storage device, a central processing unit (CPU), a hardware acceleration circuit, and a network processing unit (NPU). The storage device is arranged to store program codes. The CPU is arranged to load and execute the program codes to deal with a control function of a network speed test. The hardware acceleration circuit is arranged to provide hardware-accelerated packet forwarding. The NPU is arranged to interact with the control function performed by the CPU, and deal with processing of data packets used for the network speed test. Transmission of the data packets between the network device and another network device is performed through the NPU and the hardware acceleration circuit, without intervention of the CPU.

According to a second aspect of the present invention, an exemplary network speed test method is disclosed. The exemplary network speed test method includes: executing, by a central processing unit (CPU), program codes to deal with a control function of a network speed test; and performing, by a hardware acceleration circuit and a network processing unit (NPU), transmission of data packets used for the network speed test, without intervention of the CPU, wherein the hardware acceleration circuit provides hardware-accelerated packet forwarding, and the NPU interacts with the control function performed by the CPU, and deals with processing of the data packets used for the network speed test.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a flowchart illustrating a UL speed test method according to an embodiment of the present invention.

FIG. 3 is a diagram illustrating execution locations of steps of the UL speed test method shown in FIG. 2.

FIG. 4 is a flowchart illustrating a method employed by the upstream processing circuit 134 to generate data packets for UL speed test according to an embodiment of the present invention.

FIG. 5 is a diagram illustrating an arrangement of the SRAM that is used by the upstream processing circuit to generate data packets for UL speed test according to an embodiment of the present invention.

FIG. 6 is a diagram illustrating a Load PDU format according to an embodiment of the present invention.

FIG. 7 is a flowchart illustrating a DL speed test method according to an embodiment of the present invention.

FIG. 8 is a diagram illustrating execution locations of steps of the DL speed test method shown in FIG. 7.

FIG. 9 is a flowchart illustrating a method of receiving and parsing data packets sent from the network device for DL speed test according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

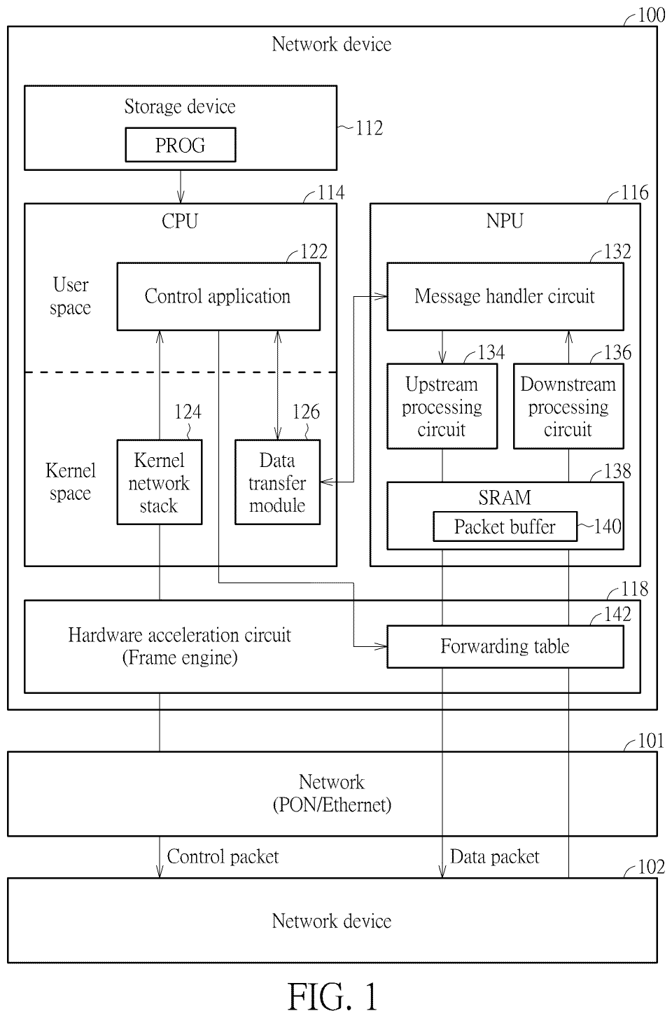

FIG. 1 is a diagram illustrating a network device 100 according to an embodiment of the present invention. The network device 100 can perform data transactions with another network device 102 via a network 101. For example, the network device 100 may be a client, and the network device 102 may be a server with a test controller, where the test controller is used to manage a network speed test procedure between a sender and a receiver. For example, the network device 100 may be a customer premise equipment (CPE) such as an optical network unit (ONU), the network device 102 may be a broadband network gateway (BNG), and the network 101 may be Ethernet or a passive optical network (PON). It should be noted that these are for illustrative purposes only, and are not meant to be limitations of the present invention. Any network device using the proposed network speed test scheme falls within the scope of the present invention.

In some embodiments of the present invention, the network speed test may be a UDP speed test. By way of example, but not limitation, the UDP speed test may comply with a TR-471 speed test protocol. For better comprehension of technical features of the present invention, the following assumes that the network speed test is a UDP speed test complying with the TR-471 speed test protocol. Regarding an UL speed test under the TR-471 speed test protocol, the network device (e.g., client) 100 acts as a sender for sending Load protocol data units (Load PDUs) at a sending rate during a trial interval, and the network device (e.g., server) 102 acts as a receiver for parsing received Load PDUs to do statistics of traffic information, including a loss sum seqErrLoss, an out-of-order sum seqErrOoo, trial interval delta time tiDeltaTime, etc. At an end of a current trial interval, the network device 102 returns a Status feedback PDU (which carries statistics information gathered for the current trial interval) to the network device 100, such that the network device 100 dynamically updates the sending rate used for a next trial interval according to the statistics information provided by the Status feedback PDU.

Regarding a DL speed test under the TR-471 speed test protocol, the network device (e.g., server) 102 acts as a sender for sending Load PDUs at a sending rate during a trial interval, and the network device (e.g., client) 100 acts as a receiver for parsing received Load PDUs to do statistics of traffic information, including a loss sum seqErrLoss, an out-of-order sum seqErrOoo, trial interval delta time tiDeltaTime, etc. At an end of a current trial interval, the network device 100 returns a Status feedback PDU (which carries statistics information gathered for the current trial interval) to the network device 102, such that the network device 102 dynamically updates the sending rate used for a next trial interval according to the statistics information provided by the Status feedback PDU.

As shown in FIG. 1, the network device (e.g., ONU) 100 includes a storage device 112, a CPU 114, a network processing unit (NPU) 116, and a hardware acceleration circuit 118. It should be noted that only the components pertinent to the present invention are illustrated. In practice, the network device (e.g., ONU) 100 may include additional components to achieve other designed functions.

The storage device 112 may be a memory such as a dynamic random access memory (DRAM), or may be any component with data storage capability. The storage device 112 is arranged to store program codes PROG. For example, the program codes PROG may include program codes of an operating system (OS) and program codes of applications. In this embodiment, the program codes PROG may include a control application (e.g., a speed test control application) 122, a kernel network stack (e.g., a network stack of a Linux kernel) 124, and a data transfer module 126. The CPU 114 may be a general purpose processor such as an ARM-based processor, and is arranged to load and execute the program codes PROG to deal with a control function of a network speed test (e.g., UDP speed test that complies with TR-471 speed test protocol), where the control application 122 is arranged to run in a user space, and the kernel network stack 124 and the data transfer module 126 are arranged to run in a kernel space.

The hardware acceleration circuit 118 acts as a frame engine, and is arranged to provide hardware-accelerated packet forwarding. The NPU 116 is a programmable application-specific integrated circuit (ASIC) customized for a particular use, rather than intended for general-purpose use. Specifically, the NPU 116 is an ASIC optimized for networking applications. In this embodiment, the NPU 116 is arranged to interact with the CPU 114 (particularly, control function performed by the CPU 114), and deal with processing of data packets (which carry Load PDUs that include test data) used for the network speed test.

The proposed network speed test scheme separates a control plane and a data plane of the network speed test, where the control plane is managed by the CPU 114, and the data plane is offloaded from the CPU 114 to the NPU 116 and the hardware acceleration circuit 118. Specifically, UL/DL transmission of the data packets between the network device (e.g., a test endpoint being a client) 100 and another network device (e.g., a test endpoint being a server) 102 is performed through the NPU 116 and the hardware acceleration circuit 118, without intervention of the CPU 114. During the network speed test period, the CPU 114 is only responsible for receiving a small number of control packets from the network device 102, sending a small number of control packets to the network device 102, sending messages and commands to the NPU 116, receiving messages from the NPU 116, and setting the configuration of the hardware acceleration circuit 118. In this way, the network speed test does not occupy much CPU resource. The hardware acceleration circuit 118 provides hardware-accelerated packet forwarding, and does not occupy any CPU resource. The NPU 116 is dedicated hardware with an optimized hardware structure for network processing. For example, the NPU 116 has an on-chip memory such as a static random access memory (SRAM) 138. Compared to an off-chip memory such as a DRAM, the SRAM 138 has higher access (read/write) efficiency due to lower access (read/write) latency. In this embodiment, a packet buffer 140 can be allocated in the SRAM 138 for buffering ingress packets sent from the network device (e.g., server) 102 and received by the NPU 116 and buffering egress packets to be sent from the NPU 116 to the network device (e.g., server) 102. In this way, the packet transfer between the network device 100 (particularly, NPU 116 of network device 100) and the network device 102 can be enhanced. By offloading the data plane of the network speed test from the CPU 114 to the NPU 116 and the hardware acceleration circuit 118, the speed test requirements of a high-speed network can still be met under a condition that the CPU 114 has limited computing power.

During the network speed test period, the control application 122 runs in the user space, and the kernel network stack 124 and the data transfer module 126 run in the kernel space. The control application 122 is arranged to deal with the control function of the network speed test. The data transfer module 126 acts as an interface between the CPU 114 and the NPU 116. Hence, the control function performed at the CPU 114 communicates with the NPU 116 via the data transfer module 126, such that the data transfer module 126 transfers commands and control messages from the control application 122 to the NPU 116, and transfers statistics messages from the NPU 116 to the control application 122. Control packets are transmitted between the control application 122 and the network device (e.g., server) 102 through the kernel network stack 124. In a case where the network speed test is the UDP speed test that complies with TR-471 speed test protocol, the control packets may include a Setup Request packet, a Setup Response packet, a Test Activation Request packet, a Test Activation Response packet, and a Status Feedback PDU. The hardware acceleration circuit 118 includes a forwarding table 142. The control application 122 is further arranged to set the forwarding table 142 for enabling the hardware-accelerated packet forwarding of the data packets (which carry Load PDUs that include test data) between the network device 100 (particularly, NPU 116 of network device 100) and the network device 102.

As mentioned above, the NPU 116 is a programmable ASIC optimized for network processing. In this embodiment, the NPU 116 is programmed to have a message handler circuit 132, an upstream processing circuit 134, and a downstream processing circuit 136. The message handler circuit 132 is arranged to communicate with the data transfer module 126. Hence, the message handler circuit 132 receives commands and control messages sent from the control application 122 via the data transfer module 126, and sends statistics messages to the control application 122 via the data transfer module 126. When the network speed test is a UL speed test, the upstream processing circuit 134 is activated to generate the data packets and send the data packets to the hardware acceleration circuit 118 for follow-up hardware-accelerated packet forwarding. When the network speed test is a DL speed test, the downstream processing circuit 136 is activated to receive the data packets forwarded from the hardware acceleration circuit 118 and parse the received data packets to generate statistics data, where the statistics data calculated at the downstream processing circuit 136 can be provided to the message handler circuit 132 for generating a statistics message and sending the statistics message to the control application 122 in response to a get statistics command sent from the control application 122.

Further details of the proposed network speed test scheme are provided as below with reference to the accompanying drawings.

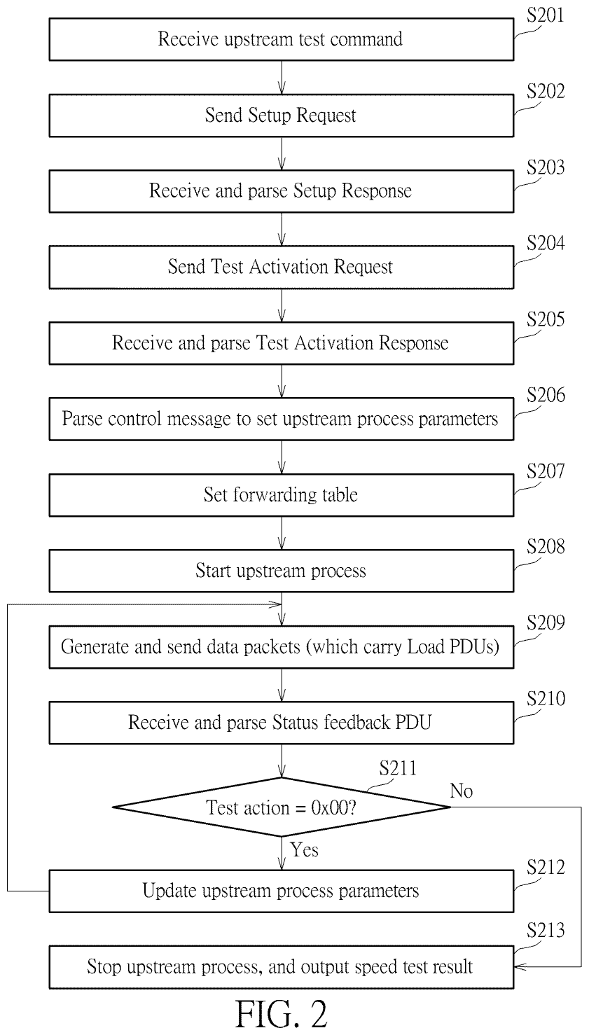

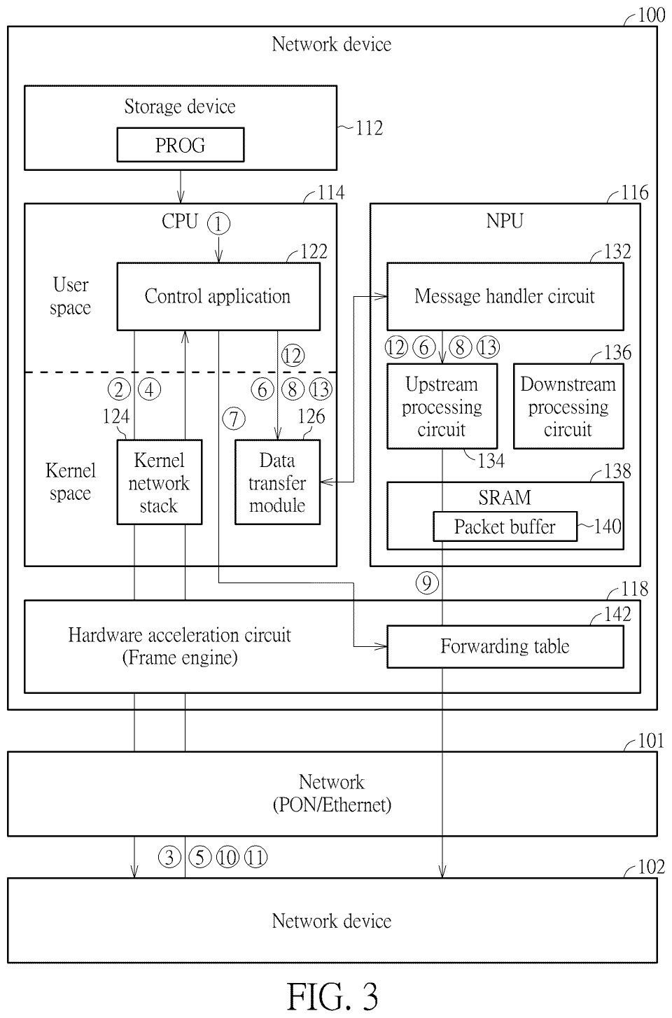

Please refer to FIG. 2 in conjunction with FIG. 3. FIG. 2 is a flowchart illustrating a UL speed test method according to an embodiment of the present invention. FIG. 3 is a diagram illustrating execution locations of steps of the UL speed test method shown in FIG. 2. At step S201 (labeled by a circled number “1” in FIG. 3), the control application 122 receives an upstream test command that may be triggered by a user input. At step S202 (labeled by a circled number “2” in FIG. 3), the control application 122 generates and sends a Setup Request packet to the network device 102. At step S203 (labeled by a circled number “3” in FIG. 3), the control application 122 receives and parses a Setup Response packet (which may indicate a new test port) that is sent from the network device 102 in response to the Setup Request packet. At step S204 (labeled by a circled number “4” in FIG. 3), the control application 122 generates and sends a Test Activation Request packet (which uses the new test port, and may carry test parameters such as a test direction and a test duration) to the network device 102. At step S205 (labeled by a circled number “5” in FIG. 3), the control application 122 receives and parses a Test Activation Response packet (which may indicate a sending rate) that is sent from the network device 102 in response to the Test Activation Request packet.

At step S206 (labeled by a circled number “6” in FIG. 3), the control application 122 sends a control message (which indicates upstream test parameters) to the NPU 116, and the NPU 116 (particularly, upstream processing circuit 134 of NPU 116) parses the control message to set upstream process parameters for a current trial interval. At step S207 (labeled by a circled number “7” in FIG. 3), the control application 122 adds a table entry (which may include a 5-tuple and a forward port) to the forwarding table 142 to enable hardware-accelerated packet forwarding between the NPU 116 and the network device 102. At step S208 (labeled by a circled number “8” in FIG. 3), the control application 122 sends an upstream test command to the NPU 116, and the NPU 116 (particularly, upstream processing circuit 134) starts an upstream process in response to receiving the upstream test command. At step S209 (labeled by a circled number “9” in FIG. 3), the NPU 116 (particularly, upstream processing circuit 134) generates and sends data packets (which are upstream packets that carry Load PDUs for UL speed test) to the hardware acceleration circuit 118, and the hardware acceleration circuit performs hardware-accelerated packet forwarding of the data packets self-generated by the upstream processing circuit 134 according to the matched entry in the forwarding table 142. At step S210 (labeled by a circled number “10” in FIG. 3), the control application 122 receives and parses Status feedback PDU that are sent from the network device 102. At step S211 (labeled by a circled number “11” in FIG. 3), the control application 122 checks a “testAction” field value included in a Status feedback header (which is parsed from the Status feedback PDU received at step S210).

If the “testAction” field value is equal to 0x00, meaning that the upstream test operates normally, the flow proceeds with step S212 (labeled by a circled number “12” in FIG. 3) to update upstream process parameters for a next trial interval. After the upstream process parameters are updated, the flow returns to step S209 to continue generating and sending data packets (which are upstream packets that carry Load PDUs for UL speed test).

If the “testAction” field value is not equal to 0x00, meaning that the upstream test should be terminated, the flow proceeds with step S213 (labeled by a circled number “13” in FIG. 3). At step S213, the control application 122 sends a stop command to the NPU 116, and the NPU 116 (particularly, upstream processing circuit 134 of NPU 116) stops the upstream process in response to receiving the stop command. In addition, the control application 122 outputs the speed test result of the UL speed test.

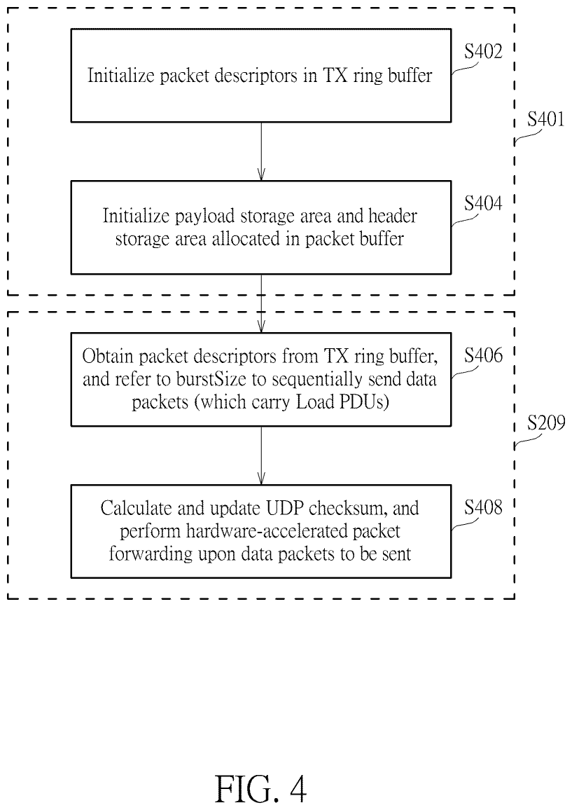

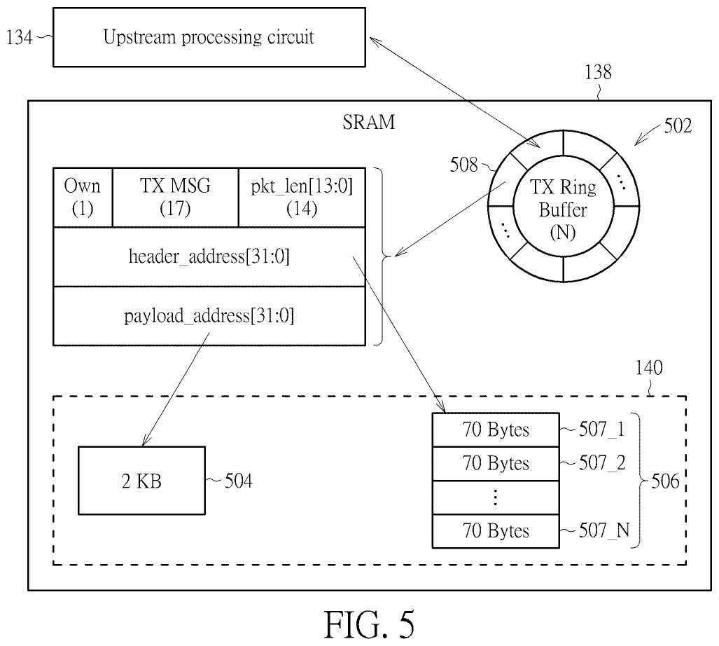

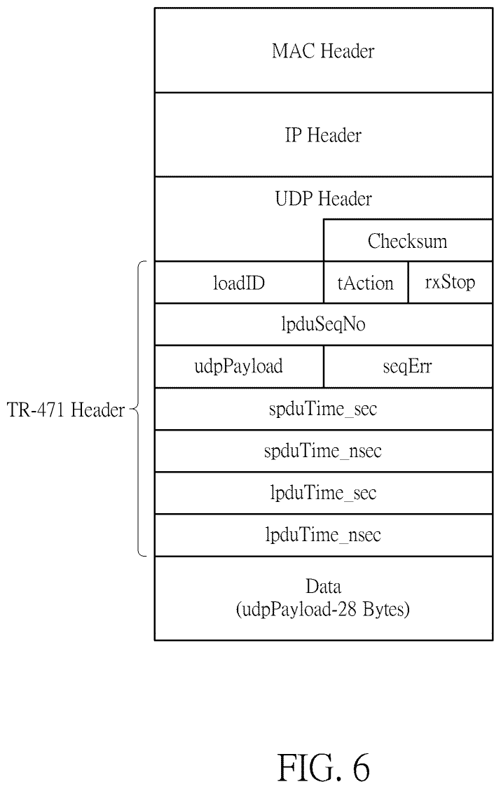

As mentioned above, the upstream processing circuit 134 self-generates data packets (which carry Load PDUs) for UL speed test. In some embodiments of the present invention, each of the data packets includes a header and a payload, headers of the data packets may be set by different header data, respectively, and payloads of the data packets may be set by the same payload data. In addition, headers of different data packets may include same field contents (e.g., Media Access control (MAC) header, Internet Protocol (IP) header, and UDP header) and per-packet field contents (e.g., lpduSeqNo, udpPayload, and lpduTime_sec of TR-471 header). Please refer to FIG. 4 in conjunction with FIG. 5 and FIG. 6. FIG. 4 is a flowchart illustrating a method employed by the upstream processing circuit 134 to generate data packets for UL speed test according to an embodiment of the present invention. FIG. 5 is a diagram illustrating an arrangement of the SRAM 138 that is used by the upstream processing circuit 134 to generate data packets for UL speed test according to an embodiment of the present invention. FIG. 6 is a diagram illustrating a Load PDU format according to an embodiment of the present invention. Before step S209 is performed, step S401 is performed to apply an initialization process to the SRAM 138 in the NPU 116. As shown in FIG. 5, a transmit (TX) ring buffer 502, a payload storage area 504, and a header storage area 506 are allocated in the SRAM 138. Specifically, each of the payload storage area 504 and the header storage area 506 can be a part of the packet buffer 140 allocated in the SRAM 138. The payload storage area 504 is arranged to store payload data. For example, the payload storage area 504 may have a size of 2 kilobytes (KB). The header storage area 506 includes N blocks 507_1, 507_2, . . . , 507_N, each arranged to store one header data. For example, each of the blocks 507_1-507_N may have a size of 70 bytes. The TX ring buffer 502 is arranged to store N packet descriptors. At step S402, the packet descriptors recorded in the TX ring buffer 502 are initialized by the upstream processing circuit 134. Each packet descriptor 508 includes one own bit, a 17-bit TX message (TX MSG) field, a 14-bit packet length (pkt_len) field, a 32-bit header address (header_address) field, and a 32-bit payload address (payload_address) field. During the initialization process of the packet descriptors 508, the own bit of each packet descriptor 508 is set by 0 to indicate that the packet descriptor 508 is processed by the NPU 116 now, the TX MSG field of each packet descriptor 508 is set to indicate that a UDP checksum (i.e., a checksum field included in a UDP header) is generated by hardware (particularly, hardware acceleration circuit 118), payload_address fields of N packet descriptors 508 are set to point to the same payload storage area 504, and header_address fields of N packet descriptors 508 are set to point to N blocks 507_1-507_N of the header storage area 506, sequentially and respectively.

At step S404, the header storage area 506 is initialized by the upstream processing circuit 134. As shown in FIG. 6, the data with a size of (udpPayload—28 Bytes) is encapsulated by a TR-471 header, a UDP header, an IP header, and a MAC header sequentially; the TR-471 header includes a plurality of fields “loadID”, “tAction”, “rxStop”, “lpduSeqNo”, “udpPayload”, “seqErr”, “spduTime_sec”, “spduTime_nsec”, “lpduTime_sec”, and “lpduTime_nsec”. According to the upstream test parameters provided by the CPU 114 (step S206), the blocks 507_1-507_N are initialized to have the same header information, including a MAC header, an IP header, a UDP header, and some fields (e.g., “loadID”, “tAction”, and “rxStop”) in a TR-471 header. Since the network speed test does not care about the Load PDU payload contents, the 2 KB payload storage area 504 can be initialized by random data.

When step S209 is performed in response to the upstream test command sent from the CPU 114, steps S406 and S408 are performed to deal with data packet generation needed by the UL speed test. At step S406, the upstream processing circuit 134 obtains available packet descriptors 508 from the TX ring buffer 502, and refers to a burstSize parameter to sequentially send data packets (which carry Load PDUs). Before one Load PDU is sent, the upstream processing circuit 134 refers to a sending rate parameter sent from the CPU 114 to assign correct values to “lpduSeqNo”, “udpPayload”, “lpduTime_sec”, “lpduTime_nsec” fields in the TR-471 header stored in one block pointed to by the header_address filed of the packet descriptor 508, sets the pkt_len field of the packet descriptor 508, and sets the own bit of the packet descriptor 508 by 1 to indicate that the NPU 116 finishes processing of the packet descriptor 508 and processing of the packet descriptor 508 is handed over to a direct memory access (DMA) controller. The “lpduSeqNo” field is set to indicate a Load PDU sequence number. The “udpPayload” field is set to indicate the UDP payload (bytes). The “lpduTime_sec” and “lpduTime_nsec” fields are set to indicate the send time of this PDU. Hence, these fields may have different values for different Load PDUs, and should be correctly set in step S406.

When the DMA controller reads the packet descriptor 508 from the TX ring buffer 502, the DMA controller reads a header from the header storage area 506 (particularly, one of the blocks 507_1-507_N that is pointed to by the header_address field), reads a payload from the payload storage area 504 pointed to by the payload_address field, combines the header and the payload to generate a data packet (which carries a Load PDU with the format shown in FIG. 6), and sends the data packet read from the packet buffer 140 to the hardware acceleration circuit 118 for follow-up hardware-accelerated packet forwarding.

The hardware acceleration circuit 118 supports a UDP checksum calculation function. At step S408, after receiving the data packet (which carries a Load PDU with the format shown in FIG. 6), the hardware acceleration circuit 118 calculates a UDP checksum and updates the UDP checksum in the UDP header shown in FIG. 6. In addition, the hardware acceleration circuit 118 searches the forwarding table 142 for a matched entry, and refers to the forwarding rule defined in the matched entry to perform hardware-accelerated packet forwarding upon the data packet generated by the NPU 116.

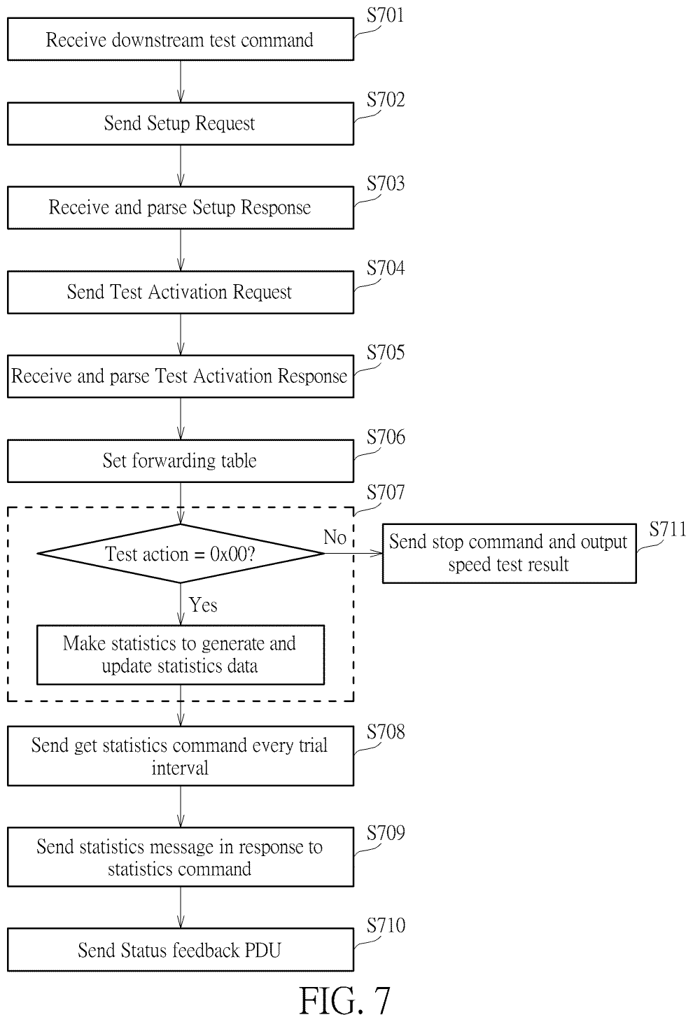

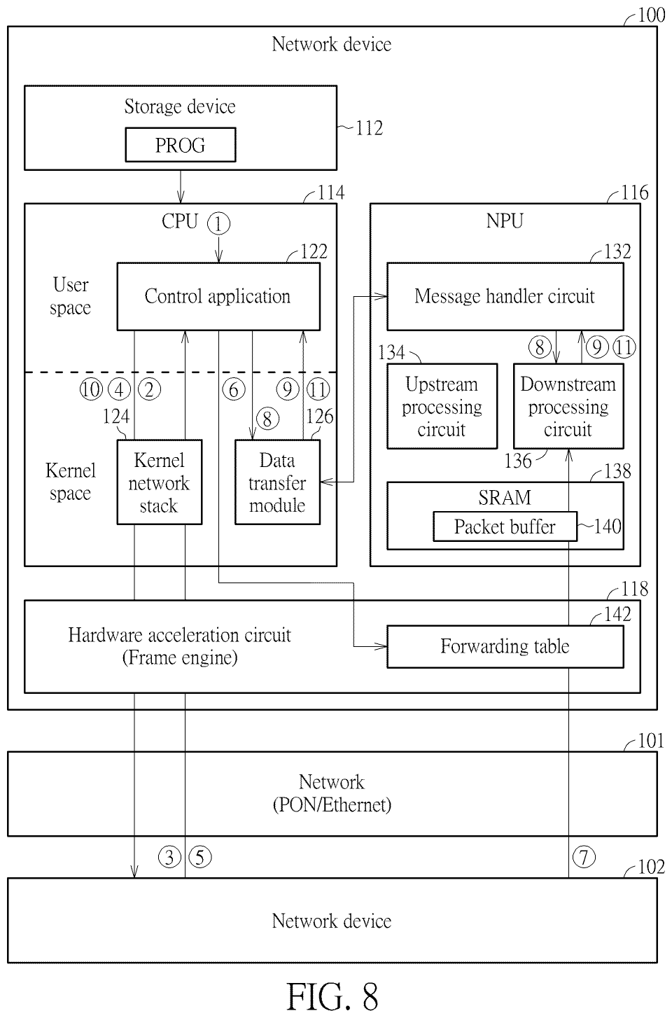

Please refer to FIG. 7 in conjunction with FIG. 8. FIG. 7 is a flowchart illustrating a DL speed test method according to an embodiment of the present invention. FIG. 8 is a diagram illustrating execution locations of steps of the DL speed test method shown in FIG. 7. At step S701 (labeled by a circled number “1” in FIG. 8), the control application 122 receives a downstream test command that may be triggered by a user input. At step S702 (labeled by a circled number “2” in FIG. 8), the control application 122 generates and sends a Setup Request packet to the network device 102. At step S703 (labeled by a circled number “3” in FIG. 8), the control application 122 receives and parses a Setup Response packet (which may indicate a new test port) that is sent from the network device 102 in response to the Setup Request packet. At step S704 (labeled by a circled number “4” in FIG. 8), the control application 122 generates and sends a Test Activation Request packet (which uses the new test port, and may carry test parameters such as a test direction and a test duration) to the network device 102. At step S705 (labeled by a circled number “5” in FIG. 8), the control application 122 receives and parses a Test Activation Response packet (which may indicate a sending rate) that is sent from the network device 102 in response to the Test Activation Request packet.

At step S706 (labeled by a circled number “6” in FIG. 8), the control application 122 adds a table entry (which may include a 5-tuple and a forward port) to the forwarding table 142 to enable hardware-accelerated packet forwarding between the NPU 116 and the network device 102.

At step S707 (labeled by a circled number “7” in FIG. 8), the hardware acceleration circuit 118 receives a data packet (which carries a Load PDU with the format shown in FIG. 6), and sends the received data packet to the NPU 116 according to a matched entry in the forwarding table 142. The NPU 116 (particularly, downstream processing circuit 136 of NPU 116) parses the received data packet to check a “testAction” field value included in a Load PDU header. If the “testAction” field value is equal to 0x00, meaning that the downstream test operates normally, the NPU 116 refers to information carried by the Load PDU header to make statistics for generating and updating statistics data that will be later used by the CPU 114 for generating a Status feedback PDU. If the “testAction” field value is not equal to 0x00, meaning that the downstream test should be terminated, the flow proceeds with step S711 (labeled by a circled number “11” in FIG. 3). At step S711, the NPU 116 (particularly, downstream processing circuit 136 of NPU 116) sends a stop command to the CPU 114, and the control application 122 outputs the speed test result of the DL speed test in response to receiving the stop command.

If the “testAction” field value is equal to 0x00, the flow proceeds with S708 (labeled by a circled number “8” in FIG. 8) after step S707. At step S708, the control application 122 sends a get statistics command to the NPU 116 every trial interval (10 millisecond (ms)). At step S709 (labeled by a circled number “9” in FIG. 8), the NPU 116 (particularly, downstream processing circuit 136 of NPU 116) generates a statistics message (which indicates seqErrLoss, seqErrOoo, tiDeltaTime, etc.) according to the statistics data and sends the statistics message to the control application 122 in response to the get statistics command.

At step S710 (labeled by a circled number “10” in FIG. 8), the control application 122 receives and parses the statistics message, and sends a Status feedback PDU to the network device 102.

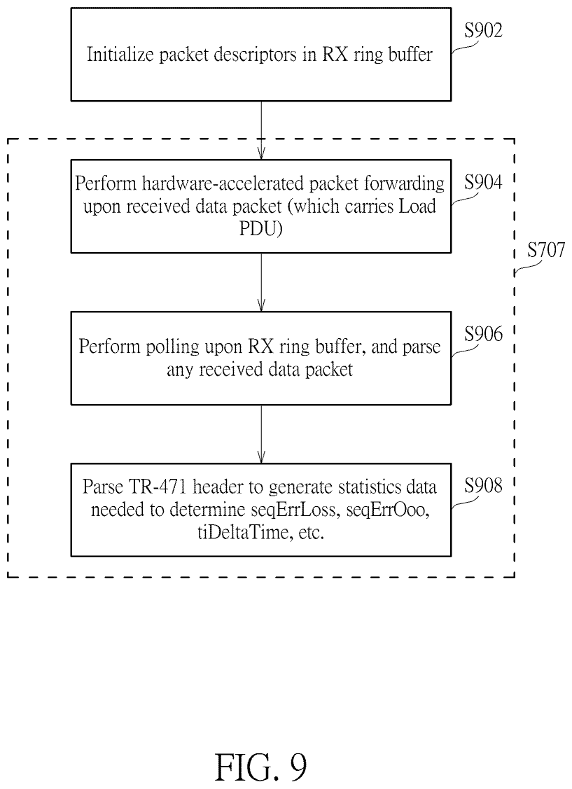

As mentioned above, the NPU 116 (particularly, downstream processing circuit 136 of NPU 116) receives data packets forwarded by the hardware acceleration circuit 118, and parses the data packets to generate statistics data. FIG. 9 is a flowchart illustrating a method of receiving and parsing data packets sent from the network device 102 for DL speed test according to an embodiment of the present invention. At step S902, the downstream processing circuit 136 initializes a receive (RX) ring buffer allocated in the SRAM 138, where the RX ring buffer is arranged to store a plurality of packet descriptors. In addition, the downstream processing circuit 136 allocates a plurality of fixed buffers in the packet buffer 140 for the packet descriptors in the RX ring buffer, respectively, where each of the fixed buffers is used to buffer a data packet (which carries a Load PDU) sent from the network device 102.

At step S904, after receiving the data packet (which carries a Load PDU) sent from the network device 102, the hardware acceleration circuit 118 forwards the received data packet to one of the fixed buffers according to a matched entry in the forwarding table 142, where a memory address of the fixed buffer that stores the received data packet is recorded in one packet descriptor in the RX ring buffer.

At step S906, the NPU 116 (particularly, downstream processing circuit 136 of NPU 116) performs a polling operation upon the RX ring buffer for checking if any data packet arrives. When detecting that a data packet arrives, the NPU 116 parses the data packet. If the data packet is a first data packet that is first received during the DL speed test, the NPU 116 (particularly, downstream processing circuit 136 of NPU 116) further records a length of a header section (which includes a MAC header, an IP header, and a UDP header) preceding a TR-471 header of the first data packet, such that the NPU 116 (particularly, downstream processing circuit 136 of NPU 116) can refer to the length to locate a TR-471 header of any second data packet that is received later than the first data packet, without parsing a header section (which includes a MAC header, an IP header, and a UDP header) of the second data packet that precedes the TR-471 header of the second data packet.

At step S908, the NPU 116 (particularly, downstream processing circuit 136 of NPU 116) parses the TR-471 header to generate statistics data needed to determine seqErrLoss, seqErrOoo, tiDeltaTime, etc. Consider a case where a received data packet is not the first data packet that is first received during the DL speed test. With the help of the recorded length of the header section (which includes a MAC header, an IP header, and a UDP header) preceding the TR-471 header, the downstream processing circuit 136 can gather the statistics data more efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network device comprising:
a storage device, arranged to store program codes;
a central processing unit (CPU), arranged to load and execute the program codes to deal with a control function of a network speed test;
a hardware acceleration circuit, arranged to provide hardware-accelerated packet forwarding; and
a network processing unit (NPU), arranged to interact with the control function performed by the CPU, and deal with processing of data packets used for the network speed test;
wherein transmission of the data packets between the network device and another network device is performed through the NPU and the hardware acceleration circuit, without intervention of the CPU.

2. The network device of claim 1, wherein the network speed test is a user datagram protocol (UDP) speed test.

3. The network device of claim 2, wherein the UDP speed test complies with a TR-471 speed test protocol.

4. The network device of claim 1, wherein the program codes comprise:
a data transfer module, arranged to run in a kernel space, and act as an interface between the CPU and the NPU; and
a control application, arranged to run in a user space, and deal with the control function.

5. The network device of claim 4, wherein the hardware acceleration circuit comprises a forwarding table used by the hardware-accelerated packet forwarding, and the control application is further arranged to set the forwarding table for enabling the hardware-accelerated packet forwarding of the data packets.

6. The network device of claim 4, wherein the program codes further comprise a kernel network stack, and control packets are transmitted between the control application and the another network device through the kernel network stack.

7. The network device of claim 4, wherein the network speed test is an upstream test, and the NPU comprises:
an upstream processing circuit, arranged to generate the data packets and send the data packets to the hardware acceleration circuit; and
a message handler circuit, arranged to receive a control message from the control application, and parse the control message to set parameters of the upstream processing circuit.

8. The network device of claim 4, wherein the network speed test is an upstream test, and the NPU comprises:
an upstream processing circuit; and
a message handler circuit, arranged to receive an upstream test command from the control application, and instruct the upstream processing circuit to start generating the data packets and sending the data packets to the hardware acceleration circuit in response to the upstream test command.

9. The network device of claim 4, wherein the network speed test is an upstream test, and the NPU comprises:
a message handler circuit, arranged to receive a stop command from the control application.

10. The network device of claim 4, wherein the network speed test is a downstream test, and the NPU comprises:
a downstream processing circuit, arranged to receive the data packets from the hardware acceleration circuit and parse the data packets to generate statistics data; and
a message handler circuit, arranged to receive a get statistics command from the control application, and further arranged to generate a statistics message according to the statistics data and send the statistics message to the control application in response to the get statistics command.

11. The network device of claim 10, wherein each of the data packets comprises a TR-471 header; the statistics data is generated from parsing TR-471 headers of the data packets; and the downstream processing circuit is further arranged to record a length of a header section preceding a TR-471 header of a first data packet that is first received during the downstream test, and refer to the length to locate a TR-471 header of a second data packet that is received later than the first data packet, without parsing a header section of the second data packet that precedes the TR-471 header of the second data packet.

12. The network device of claim 4, wherein the network speed test is a downstream test, and the NPU comprises:
a message handler circuit, arranged to send a stop command to the control application.

13. The network device of claim 1, wherein the network speed test is an upstream test; each of the data packets comprises a header and a payload; headers of the data packets are set by different header data, respectively; and payloads of the data packets are set by same payload data.

14. The network device of claim 13, wherein the NPU comprises:
a memory, comprising:
a payload storage area, arranged to store payload data;
a header storage area, comprising:
a plurality of blocks, each arranged to store header data;
a transmit (TX) ring buffer, arranged to store a plurality of packet descriptors, each comprising:
a header address field, arranged to store an address of the payload storage area; and
a payload address field, arranged to store an address of one of the blocks allocated in the header storage area; and
an upstream processing circuit, arranged to obtain a packet descriptor from the TX ring buffer, and generate a data packet by setting the packet descriptor.

15. The network device of claim 14, wherein each of the plurality of packet descriptors further comprises:
a TX message field, arranged to indicate that a user datagram protocol (UDP) checksum is generated by hardware;
wherein the hardware acceleration circuit is further arranged to update a UDP checksum of the data packet after receiving the data packet.

16. The network device of claim 1, wherein the network device is an optical network unit (ONU).

17. A network speed test method comprising:
executing, by a central processing unit (CPU), program codes to deal with a control function of a network speed test; and
performing, by a hardware acceleration circuit and a network processing unit (NPU), transmission of data packets used for the network speed test, without intervention of the CPU, wherein the hardware acceleration circuit provides hardware-accelerated packet forwarding, and the NPU interacts with the control function performed by the CPU, and deals with processing of the data packets used for the network speed test.

18. The network speed test method of claim 17, wherein the network speed test is a user datagram protocol (UDP) speed test.

19. The network speed test method of claim 18, wherein the UDP speed test complies with a TR-471 speed test protocol.

20. The network speed test method of claim 17, wherein the network speed test method is employed by an optical network unit (ONU).
